(19) United States
(12) Patent Application Publication
(10) Pub. No.: US 2009/0288069 A1
(43) Pub. Date: Nov. 19, 2009

(54) Dynamic Declarative Application Description

(75) Inventors: Simon David Kent, Redmond, WA (US); Siddharth Jayadevan, Seattle, WA (US); Vladimir Nedkov Hristov, Redmond, WA (US); Christopher D. Hackmann, Redmond, WA (US); William Emeric Aitken, Mercer Island, WA (US); Antony Scott Williams, Mercer Island, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: One Microsoft Way, Redmond, WA (US)

(21) Appl. No.: 12/121,497

(22) Filed: May 15, 2008

(51) Int. Cl. G06F 9/44

(52) U.S. Cl. 717/121

(57) ABSTRACT

Embodiments described herein are directed to dynamically reconfiguring at least a portion of an operating software application. In one embodiment, a computer system receives an edit indicating that at least one portion of an operating software application is to be edited, where the edit includes changes that are to be dynamically applied to the application. The computer system instantiates dynamic configuration builders designed to implement application changes as indicated by the received edit and determines which portions of the application are to be suspended while the changes to the application are implemented. The computer system suspends the determined application portions until the application changes are implemented and implements the changes indicated by the edit on the suspended portion of the application, while the remainder of the application continues operating. The computer system also dynamically reconfigures the application with the implemented changes, where the reconfiguring includes reinitializing the suspended application portions.

### BACKGROUND

Computers have become highly integrated in the workforce, in the home, and in mobile devices. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

Software applications are typically written using some type of high-level programming language. Although many languages are in use today, most fall into one of two categories: procedural and declarative languages. In procedural languages, the developer typically writes a series of statements, referred to as functions or routines, which are to be computationally carried out in sequence. Procedural languages may include ASP, PERL, Python and C, among others. Such languages generally require a high level detail regarding event handling and state changes. This is more pronounced in cases where the user interface changes as a result of various user inputs.

Declarative languages have alleviated some of this burden by allowing developers to generally specify how to handle certain events or state changes without having to write code for each specific situation. However, many times declarative languages lack the dynamism to allow the declarative specification of rich data driven applications. Moreover, declarative languages often limit the types of modifications that can be performed during operation of the application, without having to terminate, recompile, and restart the application.

### BRIEF SUMMARY

Embodiments described herein are directed to dynamically reconfiguring at least a portion of an operating software application. In one embodiment, a computer system receives an edit indicating that at least one portion of an operating software application is to be edited, where the edit includes changes that are to be dynamically applied to the application. The computer system instantiates dynamic configuration builders designed to implement application changes as indicated by the received edit and determines which portions of the application are to be suspended while the changes to the application are implemented. The computer system suspends the determined application portions until the application changes are implemented and implements the changes indicated by the edit on the suspended portion of the application, while the remainder of the application continues operating. The computer system also dynamically reconfigures the application with the implemented changes, where the reconfiguring includes reinitializing the suspended application portions.

In another embodiment, a computer system receives an indication that one or more portions of an application are to be reconfigured while the application is operating. The computer system instantiates dynamic configuration builders configured to implement application reconfigurations as indicated by the received indication and determines which static code pieces are to be used to perform the reconfigurations. The configuration builders access static code to provide those static as code pieces that are to be used to perform the reconfigurations. The computer system receives a call from at least one of the static code pieces for a portion of dynamic code to perform the reconfigurations based on the indication and reconfigures the indicated portion of the application using the dynamic code portion to modify the static code pieces.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a computer architecture in which embodiments of the present invention may operate including dynamically reconfiguring at least a portion of an operating software application.

FIG. 2 illustrates a computer architecture in which embodiments of the present invention may operate including allowing a user to reconfigure an application by editing data, where static software code is configured to call dynamic software code to perform dynamic reconfigurations received from a user.

FIG. 3 illustrates a flowchart of an example method for dynamically reconfiguring at least a portion of an operating software application.

FIG. 4 illustrates a flowchart of an example method for allowing a user to reconfigure an application by editing data, where static software code is configured to call dynamic software code to perform dynamic reconfigurations received from a user.

### DETAILED DESCRIPTION

Embodiments described herein are directed to dynamically reconfiguring at least a portion of an operating software application. In one embodiment, a computer system receives an edit indicating that at least one portion of an operating software application is to be edited, where the edit includes changes that are to be dynamically applied to the application. The computer system instantiates dynamic configuration builders designed to implement application changes as indicated by the received edit and determines which portions of the application are to be suspended while the changes to the application are implemented. The computer system suspends the determined application portions until the application changes are implemented and implements the changes indicated by the edit on the suspended portion of the application, while the remainder of the application continues operating. The computer system also dynamically reconfigures the application with the implemented changes, where the reconfiguring includes reinitializing the suspended application portions.

In another embodiment, a computer system receives an indication that one or more portions of an application are to be reconfigured while the application is operating. The computer system instantiates dynamic configuration builders configured to implement application reconfigurations as indicated by the received indication and determines which static code pieces are to be used to perform the reconfigurations. The configuration builders access static code to provide those static as code pieces that are to be used to perform the reconfigurations. The computer system receives a call from at least one of the static code pieces for a portion of dynamic code to perform the reconfigurations based on the indication and reconfigures the indicated portion of the application using the dynamic code portion to modify the static code pieces.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry or transport desired program code means in the form of computer-executable instructions or data structures and which can be accessed by a general purpose or special purpose computer. Combinations of the above should also be included within the scope of computer-readable media.

However, it should be understood, that upon reaching various computer system components, program code means in the form of computer-executable instructions or data structures can be transferred automatically from transmission media to physical storage media. For example, computer-executable instructions or data structures received over a network or data link can be buffered in RAM within a network interface card, and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of as implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

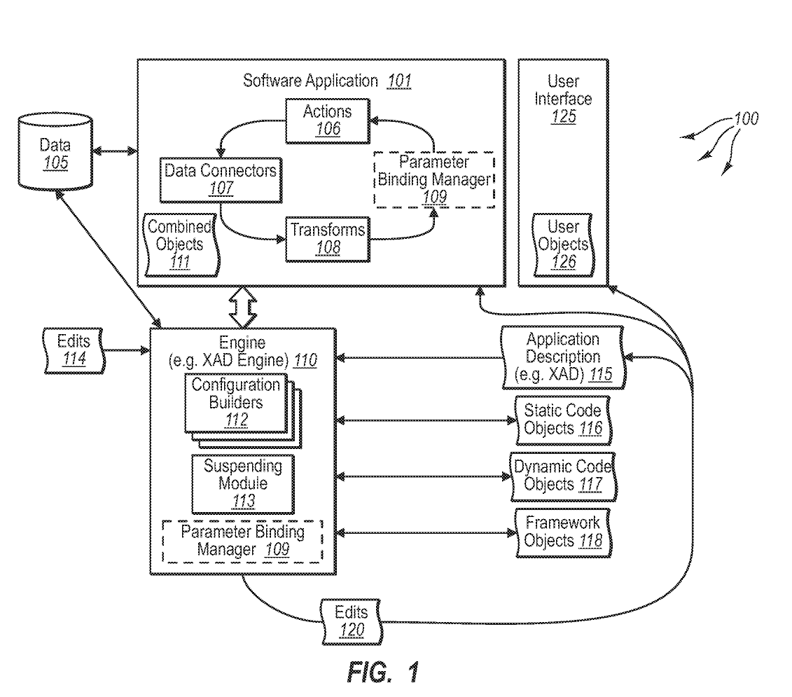

FIG. 1 illustrates a computer architecture 100 in which the principles of the present invention may be employed. In some embodiments, the elements of FIG. 1 may be implemented in or otherwise be a part of a computer system. User interface 125 may be any type of textual, graphical or other type of user interface. User interface (UI) 125 may be configured to display portions of software application 101. Additionally or alternatively, UI 125 may display user objects 126. User objects may include buttons, windows, links, graphics, icons or other graphical objects. In some cases, user objects may act as labels or indicators of underlying functionality provided by software application 101.

Application TOT may be any type of software application, designed for any purpose. The application may include multiple components or only a single component. In some cases, application 101 may be generated, compiled or stitched together at runtime. Engine 110, may be configured to perform all or a portion of the as generation, compilation or stitching together at runtime. These functions may also be performed by engine 110 at some other time before runtime. Engine 110 may be configured to receive application description portions 115. In some embodiments, application description portions 115 may include various software objects which may be used to create a working software application. The software objects may be tagged with one or more tags which declaratively indicate how the software objects are to be used, individually and in conjunction with other software objects. Such software objects may form the basis for various portions of software application functionality and may be declaratively stitched together by engine 10, as indicated above.

Engine 110 may also be configured to receive framework objects 118. Framework objects may include any of user objects 126 as well as other application-oriented framework portions used in generating a software application. This may include libraries, bindings or other objects. Engine 110 may include parameter binding manager 109. Parameter binding manager 109 may be configured to access application description portions 115 including software objects and tags. Manager 109 may map portions of the application description identified by the tags to various software objects using reflection. Reflection, as used herein, includes accessing properties associated with the software objects, which in some cases, involves viewing metadata associated with the software objects. Parameter binding manager 109 may also be configured to bind the software objects' properties to various portions of the application description (e.g. 115) based on different declarative rules included in the software object properties associated with the software object. In some cases, software object properties may be bound to data items. Application description 115 may include such data items to which properties may be bound. Additionally or alternatively, software object properties may be bound to data items that are not as included in the application description.

Engine 110 may be further configured to access data 105 and generate combined objects 11T. Data 105 may be any type of information usable by engine 110 to generate software application 101. Moreover, data 105 may be accessible by application 101 on an ongoing basis. Thus, as a user interacts with application 101, data may be streamed or otherwise sent to either or both of application 101 and engine 110. Combined objects 111 indicates one or more software objects stitched together or otherwise combined by engine 110. In some cases, combined objects 111 may form the basis of software application TOT or may themselves comprise application TOT.

Software application 101 may be continually updated and altered as a result of a passage of time or due to interaction from a user or other application. For example, some action may occur (e.g. action 106) that indicates that software application 101 is to be modified. In some cases, this action may be a change in data. Such a change in data may indicate to engine 110 that the change in data is to be translated into changes to the software application. Data connectors 107 may be used to identify which data is to be modified and may be configured to communicate with data 105 to retrieve the updated information. Transforms 108 may be used to transform, reformat, or otherwise modify the retrieved data before transferring it to parameter binding manager 109. Parameter binding manager 109, although shown as part of engine 110, may also play an integral role as part of application 101 including remapping various tags and binding software object properties to portions of application description 115. Parameter binding manager 109 may also be configured to interact directly with user interface 125, providing UI 125 with updated information that is to be displayed to a computer user.

As further indicated in FIG. 1, engine 110 may be a XAD engine. XAD, which is short for extensible markup language (XML) Application Framework (XAF) Application Definition (XAD) language, is a declarative or descriptive language. In some cases, XAD may be used to author XAF applications (e.g. application 101) based on the XAF platform. In some cases, XAD may indicate how to create a runtime object graph based on user-configurable construction information and/or application description portions 115. A XAD engine (e.g. engine 110), in conjunction with parameter binding manager 109, may process or execute the application description to create objects which view and/or process data. Thus, XAD may be used within the application framework to provide a standard and simple means of stating actions or other occurrences within the framework.

Using XAD, in some cases, a developer may be able to avoid writing the actual code for the objects that do the data processing. For example, the developer may only need to write the files for the declarative application that are ultimately compiled and executed. Furthermore, XAD offers progressive levels of abstraction to assist in design, strong typing, a high degree of static checking, and a high degree of extensibility. XAD also allows manipulation of heterogeneous data. Although XAF and XAD are mentioned herein and may be incorporated in one or more embodiments, it will be understood by one skilled in the art that functionality provided by either or both of XAD and XAF may additionally or alternatively be provided by other software applications, computer systems, or functionality providing entities.

XAF, as used herein, is a software application framework for generating a runtime structure for a given software application and for managing execution of the software application. Application 101 may be generated by an application framework that includes a collection or graph of connected application components. Functionalities of an application configured according to the application framework are enabled by dynamically configuring groups of application components into component domains where each domain is configured to enable a given functionality of the application, for example, displaying a picture in a word processing document.

In order to generate a runtime structure for the application, an application may pass an application description for each piece of application functionality to an application description engine. The application description provides declarative rules for structuring and composing the component domains, and the application description engine is operative to interpret the declarative rules for creating and reconfiguring the component domains as required based on data events received by the application. Data events, as used herein, may be any type of software message, user input, or other indication that something has occurred that may affect the software application. Data events may occur, for example, when a user clicks a mouse to interact with the application, or when an error message is presented during processing of the application.

In some cases, XAF may be configured to track dependencies such that data evaluations and object graph constructions may be incrementally updated when data changes. For example, XAF may track dependencies in data 105 such that software application 101 may be incrementally updated when data 105 is updated. In some embodiments, this incremental updating is carried out automatically by XAF.

In some embodiments, engine 110 may invoke a configuration builder 112 associated with at least one of application 101's entry points. This results in one or more objects being created, and possibly some objects being registered for initialization. These initializations may be performed, which may result in more a configuration builders being invoked, which may result in more objects being created, and perhaps more objects being registered for initialization. In some cases, as long as there are objects registered for initialization, engine 110 will continue to initialize them. Engine 110 may then be cycled to continue this process.

As further illustrated in FIG. 1, engine 110 may be configured to receive edits 114. Edits 114 may include an indication that at least one portion of an operating software application is to be edited. For example, while software application 101 is running on a computer system, a computer user may desire to edit one or more parts of the application. These parts may include user objects 126 or any other part of application 101. In some cases, one or more configuration builders 112 may be instantiated by engine 110 to implement application changes as indicated by edits 114.

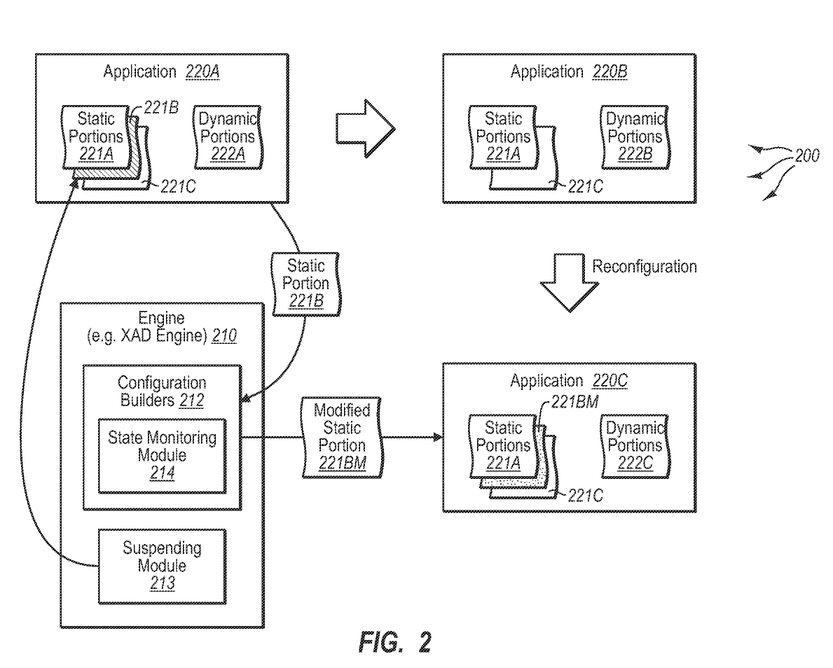

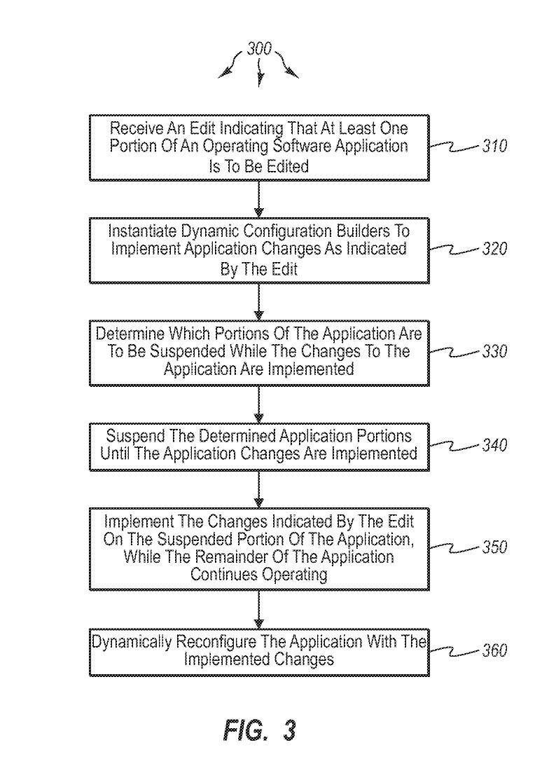

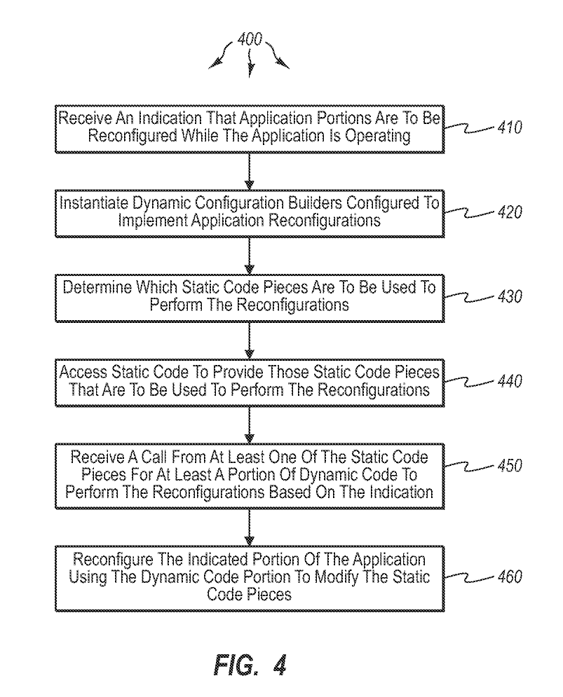

In some cases, it may be advantageous to temporarily suspend or shut down portions of application 101 while edits are made. Engine 110 may be configured to determine which portions of application 101 are to be suspended while the changes to the application are implemented. Suspending module 113 may be configured to suspend those portions of the application for which it was determined that suspension was beneficial or necessary. Engine 110 may implement the changed indicated in edits 114 on the suspended portions of the application. In some embodiments, the entire application may be suspended while the changes are implemented. Alternatively, in some embodiments, only a portion of the application may be suspended while the changes are implemented. In such cases, the remainder of the application may continue running while the edits are being performed. Edits to the application (e.g. edits 120) may be passed on to any of application description portions 115, user interface 125 and software application 101. These and other concepts will be explained in greater detail below with regard to methods 300 and 400 of FIGS. 3 and 4, respectively, and in view of architecture 200 of FIG. 2.

FIG. 2 illustrates a computer architecture 200 in which the principles of the present invention may be employed. FIG. 3 illustrates a flowchart of a method 300 for dynamically reconfiguring at least a portion of an operating software application. The method 300 will now be described with frequent reference to the components and data of environments 100 and 200 of FIGS. 1 and 2.

Method 300 includes an act of receiving an edit indicating that at least one portion of an operating software application is to be edited, the edit including changes that are to be dynamically applied to the application (act 310). For example, engine 110 may receive edit 114 indicating that at least one portion of operating software application 101 is to be edited, where the edit includes changes that are to be dynamically applied to application 101. In some cases, the edits to the application include edits to model data within the application. For example, application 101 may be configured to edit (or may currently be editing) data that corresponds to a model. In such cases, both the application and the model data are editable data, and may be edited as indicated in edit 114. In cases where the model includes various data types, a user may be able to edit all or only a portion of data types in the model. In some situations, the ability to edit certain types of data may correspond to the user's system access rights.

As indicated above, application 101 may include one or more extension points through which code portions can be added or removed. These code portions may include static code objects 116, dynamic code objects 117 and/or framework objects 118. As used herein, static code objects may include any software code as portions that are unchangeable (or are unchangeable without shutting the corresponding software application down and recompiling the application). Dynamic code objects, as used herein, refer to software code portions that are changeable and may be modified while the corresponding software application is running. In some cases, code portions may be added through one or more of the application's extension points and dynamically recompiled while the application is running. Similarly, code portions may be removed through the extension points and the application (or a portion thereof) may be dynamically recompiled. In some cases, application 101 may be capable of editing portions of its own code using the application's extension points.

Method 300 includes an act of instantiating one or more dynamic configuration builders designed to implement application changes as indicated by the received edit (act 320). For example, engine 110 may instantiate dynamic configuration builders 112 designed to implement application changes indicated in edits 114. In some cases, configuration builders 112 may be configured to monitor and identify changes in application state for application 101. These state changes and related state information may be stored in a local or remote data store. Preserving the state changes allows for application reconfiguration while maintaining state. This concept will be explained in greater detail below.

Method 300 includes an act of determining which portions of the application are to be suspended while the changes to the application are implemented (act 330). For example, engine 110 may determine which portions of application 101 are to be suspended while the changes to the application indicated in edits 114 are implemented. For instance, as depicted in FIG. 2, application 220A may include static portions 221A, 221B and 221C, along with dynamic portions 222A. Engine 210 may determine that edits 114 indicate that changes are to be made to static portion 221B. Based on this determination, engine 110 may determine that portion 221B is to be suspended while the changes to application 220A are being implemented. In determining which code portions to suspend, care should be taken to ensure that the minimal set of application portions that allows the indicated changes to be performed be suspended. In other words, each received edit may be implemented by suspending certain portions of application 220A. For each received edit, it is thus important to determine the minimal set of code portions that are to be suspended to implement the changes. It should also be noted, however, that any and all portions of the application may be suspended, as determined by engine 110.

Method 300 includes an act of suspending the determined application portions until the application changes are implemented (act 340). For example, suspending module 213 may suspend static portion 221B until the changes to application 220A are implemented. Thus, when static portion 221B is suspended, as is depicted in application 220B, only static portions 221A and 221C are still running, along with dynamic code portions 222B. Static portion 221B may be sent to configuration builders 212 for modification.

Method 300 includes an act of implementing the changes indicated by the edit on the suspended portion of the application, wherein the remainder of the application continues operating (act 350). For example, configuration builders 212 may implement the changes to code portion 221B indicated in edit 114, while the remainder of application 220A continues running (e.g. application 220B). The edits may be minor or extensive, and may thus increase or decrease the time spent in modification. Engine 210 may include state monitoring module 214 which may monitor and assess current state configurations in static code portion 221B as it is accessed in application 220A. State monitoring module 214 may be configured to store current state settings in static portion 221B and/or application 220A as a whole. Configuration builders 212 may be configured to access the stored state information and ensure that all current state configurations are transferred to modified static portion 221BM after it is modified. This ensures that, after reconfiguration, state is maintained.

Method 300 includes an act of dynamically reconfiguring the application with the implemented changes, where the reconfiguring includes reinitializing the suspended application portions (act 360). For example, engine 210 may dynamically reconfigure application 220B with the changes implemented by configuration builders 212. The reconfiguring includes reinitializing suspended static portion 221B (now modified portion 220M) in application 220C. Thus, reconfigured application 220C includes original static portions 221A and 221C, as well as modified static portion 221BM and dynamic portions 222C. In some cases, application 220C is dynamically reconfigured with the implemented changes at runtime.

FIG. 4 illustrates a flowchart of a method 400 for allowing a user to reconfigure an application by editing data, where static software code is configured to call dynamic software code to perform dynamic reconfigurations received from a user. The method 400 will now be described with frequent reference to the components and data of environment 200 of FIG. 2.

Method 400 includes an act of receiving an indication that one or more portions of an application are to be reconfigured while the application is operating (act 410). For example, engine 110 may receive edits 114 indicating that one or more portions of application 101 are to be reconfigured while application 101 continues to operate. Edits 114 may be received from a computer user, from a software application, or from another computer system. The edits may include any type of modification to application 101 including settings changes, code changes, or any other type of changes.

Method 400 includes an act of instantiating one or more dynamic configuration builders configured to implement application reconfigurations as indicated by the received indication (act 420). For example, engine 110 may instantiate dynamic configuration builders 112 to implement application reconfigurations as indicated by edits 114. Builders 112 may be used by engine 110 to determine, based on the received edits, what changes are to be made to application 101. The changes may affect one or more code portions, as illustrated in application 220A including static code portions 221A, 221B and 221C, as well as dynamic code portions 222A.

Method 400 includes an act of determining which static code pieces are to be used to perform the reconfigurations (act 430). For example, engine 110 may determine that static code portion 221B is to be used in performing the reconfiguration. In some cases, an application declaration (e.g. application description 115) may describe which portions of static code correspond to the edits received edits 114. Such application declarations may be stored in a repository, either locally or remotely. Although only three static code portions are shown in application 220A, and although only one is shown as being suspended and modified, it should be understood that application 220A may include any number of static and/or dynamic code portions. Moreover, any number of code portions may be suspended and/or modified by engine 210.

Method 400 includes an act of at least one of the instantiated dynamic configuration builders accessing static code to provide those static code pieces that are to be used to perform the reconfigurations (act 440). For example, dynamic as configuration builders 212 may access static code portions 221A, 221B and/or 221C to provide those static pieces (i.e. 221B) that are to be used to perform the reconfiguration. Thus, for example, if a user requested in edits 114 to modify rules regarding when UI buttons are to be displayed using a red color (as opposed to a default blue color), engine 210 may determine that static code portion 212B contains the code corresponding to the indicated change(s).

In such cases, a software mechanism referred to herein as a dynamic invoker may expose portions of application 220A back to dynamic code portions 222A, such that the dynamic code can use the exposed static pieces to perform the reconfigurations. A dynamic invoker may point at various runtime pieces which reads in code (e.g. objects 116 and/or 117) from a repository and compile the code. In some cases, the application is responsible for defining the extension points through which the dynamic invoker can add or remove code. The application may be static, compiled code, but can declare extension points that allow editing of the application itself. The dynamic invoker may build at least a portion of the application based on inputs supplied by the application. Thus, dynamic code portions 222A may use static code portions 221A, 221B and/or 221C in performing the reconfigurations. In some embodiments, dynamic configuration builders 212 may include editable data. In such cases, the builders 212 may conform to a schema understandable by various static configuration builders.

Method 400 includes an act of receiving a call from at least one of the static code pieces for at least a portion of dynamic code to perform the reconfigurations based on the indication (act 450). For example, engine 210 may receive a call from static portion 221B for dynamic code portion 222A to perform the as reconfigurations based on the indication. It should be noted that while static code portions can call dynamic portions to perform reconfigurations, dynamic code may also call into static application code to perform the edits. Further code calling iterations and compilations are also possible. Thus, engine 210 may allow various code portions to call into each other to accomplish various goals, including performing application reconfigurations.

Method 400 includes an act of the at least one instantiated dynamic configuration builder reconfiguring the indicated portion of the application using the dynamic code portion to modify the static code pieces (act 460). For example, configuration builders 212 may reconfigure static code portion 221B using dynamic code portion 222A to modify static code portion 221B. Before or during the reconfiguration, application state may be monitored and stored by state monitoring module 214. Thus, upon reconfiguration (e.g. reconfigured application 220C), any state settings or other state information is maintained and updated in the reconfiguration.

In one embodiment, engine 110 may receive an edit (e.g. 114) indicating that at least one portion of an operating software application (e.g. 101) is to be edited. The edit may include changes that are to be dynamically applied to application 101. Engine 110 may instantiate dynamic configuration builders (e.g. 112) designed to implement application changes as indicated by the received edit (e.g. 114). Engine 110 may determine a minimal set of application portions (e.g. 111) that are to be suspended to allow the indicated changes to be implemented. Suspending module 113/213 may suspend the determined application portions until the application changes are implemented.

Continuing in this embodiment, at least one of the instantiated dynamic configuration builders may access static code (e.g. 116) to provide those static code pieces that are to be used to perform the edits. Engine 110 may receive a call from at least one of the static code pieces for at least a portion of dynamic code (e.g. 117) to perform the edits based on the indication, while the remainder of the application (e.g. 101) continues operating. Engine 110 may dynamically reconfigure the application with the implemented changes using the dynamic code portion to modify the static code pieces. The reconfiguring also includes reinitializing those portions of the application that were suspended. In this manner, an application may be updated and reconfigured on-the-fly, with only a minimal portion of the application being temporarily suspended to enact the requested changes.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a computer system in a computer networking environment, a method for dynamically reconfiguring at least a portion of an operating software application, the method comprising:
an act of receiving an edit indicating that at least one portion of an operating software application is to be edited, the edit including changes that are to be dynamically applied to the application;
an act of instantiating one or more dynamic configuration builders designed to implement application changes as indicated by the received edit;
an act of determining which portions of the application are to be suspended while the changes to the application are implemented;
an act of suspending the determined application portions until the application changes are implemented;
an act of implementing the changes indicated by the edit on the suspended portion of the application, wherein the remainder of the application continues operating; and
an act of dynamically reconfiguring the application with the implemented changes, the reconfiguring including reinitializing the suspended application portions.

2. The method of claim 1, wherein the edits to the application comprise edits to model data within the application.

3. The method of claim 2, wherein both the application and the model data are editable data.

4. The method of claim 1, wherein the application is dynamically reconfigured with the implemented changes at runtime.

5. The method of claim 1, wherein the application comprises extension points through which code portions can be added or removed.

6. The method of claim 5, wherein code added through the extension points is dynamically recompiled.

7. The method of claim 5, wherein the application is dynamically recompiled after code is removed through the extension points.

8. The method of claim 5, wherein the extension points allow the application to edit itself.

9. The method of claim 1, wherein the suspended application portions comprise the minimal set of application portions that allows the indicated changes to be performed.

10. The method of claim 1, wherein the dynamic configuration builders monitor and identify changes in application state for the application.

11. The method of claim 10, further comprising an act of storing application state information associated with the suspended application portions, such that upon reconfiguration, state is maintained.

12. At a computer system in a computer networking environment, a method for allowing a user to reconfigure an application by editing data, where static software code is configured to call dynamic software code to perform dynamic reconfigurations received from a user, the method comprising:
an act of receiving an indication that one or more portions of an application are to be reconfigured while the application is operating;
an act of instantiating one or more dynamic configuration builders configured to implement application reconfigurations as indicated by the received indication;
an act of determining which static code pieces are to be used to perform the reconfigurations;
an act of at least one of the instantiated dynamic configuration builders accessing static code to provide those static code pieces that are to be used to perform the reconfigurations;
an act of receiving a call from at least one of the static code pieces for at least a portion of dynamic code to perform the reconfigurations based on the indication; and
an act of the at least one instantiated dynamic configuration builder reconfiguring the indicated portion of the application using the dynamic code portion to modify the static code pieces.

13. The method of claim 12, wherein an application declaration describes which portions of static code correspond to the reconfigurations received in the indication.

14. The method of claim 13, wherein one or more application declarations corresponding to the application are stored in a repository.

15. The method of claim 12, wherein an invoker exposes one or more portions of the application back to the dynamic code, such that the dynamic code can use the exposed static pieces to perform the reconfigurations.

16. The method of claim 12, further comprising dynamic code calling into static application code to perform the reconfigurations.

17. The method of claim 12, wherein the dynamic configuration builders comprise editable data and wherein the builders conform to a schema understandable by one or more static configuration builders.

18. The method of claim 12, further comprising an act of storing application state information associated with the edited application portions, such that upon reconfiguration, state is maintained.

19. A computer program product for implementing a method for dynamically reconfiguring at least a portion of an operating software application, the computer program product comprising one or more computer-readable media having thereon computer-executable instructions that, when executed by one or more processors of the computing system, cause the computing system to perform the method, the method comprising:
an act of receiving an edit indicating that at least one portion of an operating software application is to be edited, the edit including changes that are to be dynamically applied to the application;
an act of instantiating one or more dynamic configuration builders designed to implement application changes as indicated by the received edit;
an act of determining a minimal set of application portions that are to be suspended to allow the indicated changes to be implemented;
an act of suspending the determined application portions until the application changes are implemented;
an act of at least one of the instantiated dynamic configuration builders accessing static code to provide those static code pieces that are to be used to perform the edits;
an act of receiving a call from at least one of the static code pieces for as at least a portion of dynamic code to perform the edits based on the indication, wherein the remainder of the application continues operating; and
an act of dynamically reconfiguring the application with the implemented changes using the dynamic code portion to modify the static code pieces, the reconfiguring including reinitializing the suspended application portions.

20. The method of claim 19, wherein application state information is stored such that state is maintained upon reconfiguration.
